(19) United States
(12) Patent Application Publication
(10) Pub. No.: US 2003/0233256 A1
(43) Pub. Date: Dec. 18, 2003

(54) Secure medical prescription

(76) Inventors: Rodolfo Cardenas, Powder Springs, GA (US); Vivek S. Adesh, Douglasville, GA (US)

Correspondence Address: TECHNOPROP COLTON, L.L.C., P O BOX 567685, ATLANTA, GA, 311567685

(21) Appl. No.: 10/170,288

(22) Filed: Jun. 13, 2002

(51) Int. Cl. G06F 17/60

(52) U.S. Cl. 705/3

(57) ABSTRACT

A medical prescription in which the physician's DEA number is in an encrypted format or code such as an encrypted bar code, and a method and system for securely placing a physician's DEA number in an encrypted format on a medical prescription.

### TECHNICAL FIELD

The present invention generally relates to the field of medical prescriptions and preparation of such prescriptions and more specifically relates to medical prescriptions wherein the physician's Drug Enforcement Agency number is in an encrypted format and to a method and system for preparing such medical prescription.

### PRIOR ART

A medical prescription is a document that instructs the pharmacist or pharmacy on which medications to distribute to a patient and instructs the patient on how to take the prescribed medication. Generally, medical prescriptions comprise the patient's information (such as name and age), the date that the medical prescriptions must be filled, the abbreviation “Rx” that means “take thou”, the name of the medication or compound in the medication, the quantity and number of refills, the directions for taking the medication, the physician's information (such name), and the physician's signature. It already is known that a medical prescription can be in a bar coded format and/or a written format, specifically the drug product code, such as a Universal Product Code (UPC).

For some medicines, particularly opiates, medical prescriptions also must include a physician's prescribing number or Drug Enforcement Agency number (DEA number). The DEA number allows the DEA to track a physician's medical prescription history of certain controlled substances and provides one more safeguard against unauthorized people gaining access to drugs and other controlled substances. Because the DEA number is important in controlling the dissemination of drugs, certain elements have attempted to gain access to physicians' DEA numbers. As medical prescriptions, particularly those requiring a physician's DEA number for dispensation, must be in writing, physicians typically are forced to expose their DEA numbers to the public via the written medical prescriptions. Specifically, people can access the physician's DEA number on the medical prescriptions. As the incentive to obtain a physician's DEA number is high, physicians are forced to be protective of the number.

Further, the Department of Justice has suggested that the mass dissemination of physician's DEA numbers can weaken the DEA registration system. As the DEA registration number system was implemented as a way to successfully track controlled substances from the time they are manufactured until the time they are dispensed to the patient, the mass dissemination of DEA number is problematic. The DEA numbers in the hands of people who sell and use drugs illicitly could lead to more fraudulent medical prescriptions.

Thus, there is a need for a medical prescription that comprises the physician's DEA number in an encrypted format. There also is a need for a method for securely placing a physician's DEA number on medical prescriptions. There also is a need for system that can be used to prepare medical prescriptions with the physician's DEA number in an encrypted format. It is to these needs that the present invention is directed.

### BRIEF SUMMARY OF THE INVENTION

Briefly, the present invention is a medical prescription in which the physician's DEA number is in an encrypted format or code, for example an encrypted bar code. Further, the present invention is method and system for securely placing a physician's DEA number in an encrypted format on a medical prescription. The placement of the encrypted bar code, representing the physician's DEA number, can help prevent unauthorized people from gaining access to the physician's number, yet still allow a pharmacy or other dispensing agency to ensure that the prescription is legitimate and to allow the DEA to track certain controlled substances.

The present invention, in its simplest form, comprises (1) a prescription having a physicians' DEA number thereon in an encrypted format; (2) a method for producing a secure medical prescription comprising the steps of (a) converting the physician's DEA number into an encrypted code, for example an encrypted bar code, and (b) affixing the encrypted code onto a medical prescription; and (3) a system for carrying out the method and producing the prescription. The encrypted code should be in a format that requires a decryption code/method to read the encrypted code. The encrypted code can require special decryption software, such as decryption software, to decrypt the encrypted code. Such decryption software can be provided to pharmacies or other dispensing agencies or can be located on a central server to which pharmacies or other dispensing agencies have access.

Further, the present invention comprises a system for securely placing a physician's DEA number in an encrypted format on medical prescriptions. More particularly, such a system can include a system in which (1) a physician logs onto a computer or other hardware or encryption device, which optionally controls access to the system; (2) optionally the physician inputs into or retrieves from the computer patient data; (3) optionally the physician inputs or retrieves information regarding the drug the physician intends to prescribe; (4) optionally the physician is queried whether he wants his DEA number to be affixed to the medical prescription and if the physician wants his DEA number on the medical prescription, the physician's DEA number is converted into an encrypted code; and (5) the encrypted code (optionally along with the other typical information) is affixed to medical prescription paper with the encrypted DEA number, or to other appropriate devices for affixing the encrypted DEA number, such as for example stickers.

The present invention also is an improved process for preparing secure medical prescriptions by providing a computer based medical prescription writing program, allowing secure access to the medical prescription writing program; entering a medical prescription into the medical prescription writing program; and associating a specific physician with a database file comprising the specific physician's DEA number, wherein the improvement comprises the steps of encrypting the specific physician's DEA number and affixing the encrypted physician's DEA number to the medical prescription.

These features, and other features and advantages of the present invention, will become more apparent to those of ordinary skill in the relevant art when the following detailed description of the preferred embodiments is read in conjunction with the appended drawings in which like reference numerals represent like components throughout the several views.

### BRIEF DESCRIPTION OF THE FIGURES

FIG. 1 is an illustrative medical prescription of the present invention

FIG. 2 is a flow diagram of the method of one embodiment of the present invention.

FIG. 3 is a flow diagram of the system of one embodiment of the present invention.

### DETAILED DESCRIPTION OF EMBODIMENTS

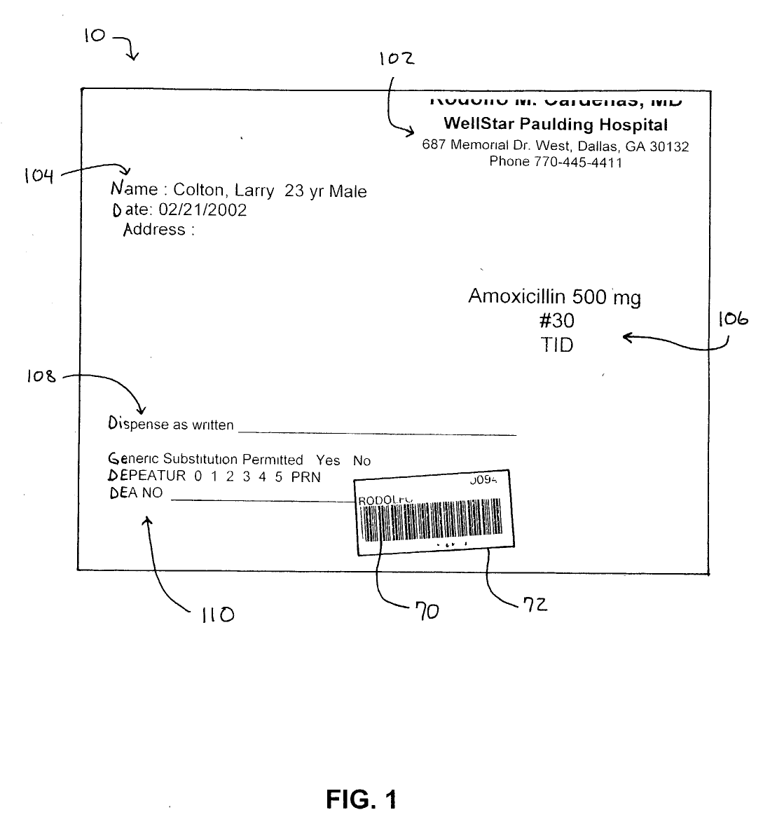

Referring to FIG. 1, the medical prescription 10 shown is an illustrative medical prescription embodiment of the present invention. As shown, medical prescription 10 comprises the typical information written or printed on medical prescriptions generally including the physician's information 102 such as name, address, phone number, personal identification number; the patient's information 104 such as name, age, sex, and address; the prescribed drug's information 106, such as name, the strength, the quantity, the dosage, the refill amount, and whether a substitute; a line 108 for the physician to execute the medical prescription; and a line 110 for the physician's DEA number. The invention further includes an encrypted code, such as barcode 70, representing the physician's DEA number.

The encryption of the physician's DEA number can aid in preventing patients and third parties from gaining access to the physician's DEA number. The patient will see the medical prescription and see the encrypted DEA number. As the DEA number is encrypted, the patient will not have access to the physician's DEA number. Further, third parties will not have access will not have access to the physician's DEA number. A pharmacy can decrypt the encrypted code and if the decrypted code matches the physician's DEA number, medical prescription 10 can be honored.

More specifically, medical prescription 10 can make use of known encryption and decryption software and devices. Encrypted code 70 of medical prescription 10 contains encrypted information to ensure security. Once medical prescription 10 arrives at the pharmacy or agency filling the prescription, encoded code 70 can be decrypted to reveal the information. One method of encryption is through the use of encrypted bar codes. Other methods of encryption are available to the present invention such as the methods in U.S. Pat. No. 6,345,104 to Rhoads, disclosing “Digital watermarks and methods for security documents.”

The encrypted code 70 also may be scrambled to make the data unreadable to anyone other than the intended recipient, that is the pharmacy or other dispensing agency filling the prescription. This type of encryption is useful in ensuring the privacy of data that is stored on medical prescription 10. In one embodiment, encrypted code 70 is scrambled to a level that a person cannot use an ordinary scanner, such as a barcode scanner, without decryption software, to determine the physician's DEA number. For example, if a person could use a common barcode scanner on encrypted barcode 70, the person would be able to read a group of number, which will not be the physician's DEA number. Thus, the pharmacy or other dispensing agency filling prescription 10 will need decryption software or codes to verify the match between the DEA number of a specific physician and encrypted code 70.

In one embodiment of the present invention, the encrypted code is an encrypted barcode 70. Encrypted barcodes 70 are preferable, as barcode scanners and computers are prevalent at pharmacies and physician's offices, and can allow medical prescription 10 to be implemented relatively easily with the barcode systems already in place at pharmacies and other dispensing agencies. When the methods of encryption/decryption of the present invention, which can be common or known encryption/decryption software and technologies, are integrated into the processes of the present invention, the present invention preserves secrecy of the physician's DEA number when transferred onto the medical prescription paper. A bar scanner at the pharmacies or other dispensing agencies will read the encrypted barcode 70. However, as the pharmacy or the other dispensing agency filling medical prescription 10 will need to able to decrypt encrypted barcode 70 and verify it against the physician's DEA number, the decryption method must be available to such pharmacies or other dispensing agencies.

Other coding and encrypting techniques also are suitable for the present invention. For example, digital coding, block coding and circular coding techniques having alternating patterns or colors would suffice.

Thus, a first aspect of the present invention is a medical prescription 10 comprising an encrypted physician DEA number 70. This aspect can be, for illustrative purposes, a pad of preprinted prescription forms for a specific physician and having the specific physician's encrypted DEA number imprinted thereon, or a sheet of stickers comprising a specific physician's encrypted DEA number imprinted thereon that can be placed on an otherwise blank common prescription form. The ability to have an encrypted DEA number available for use on a prescription form is advantageous to the medical profession and to the public at large.

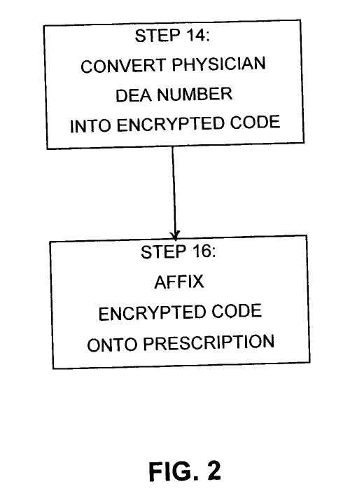

Referring now to FIG. 2, a method for securely placing a physician's DEA number on medical prescription 10 is shown in a flowchart. The general method comprises the steps of encrypting the physician's DEA number into encrypted code (step 14) and then affixing encrypted code onto a medical prescription or other substrate (step 16). After the physician's DEA number is encrypted into an encrypted code (step 14), the encrypted code can be affixed to medical prescription 10 (step 16) through any conventional method. A first method of affixing encrypted code onto medical prescription 10 is by directly printing encrypted code onto medical prescription paper. A second method of affixing encrypted code onto medical prescription 10 is to print the encrypted code onto a sticker and then affixing the sticker with encrypted code onto the medical prescription 10. This second method is shown in FIG. 1, where encrypted barcode 70 is printed onto a sticker 72, which then is affixed to medical prescription 10.

Thus, a second aspect of the present invention is a method for taking a physician's DEA number, encrypting the DEA number, and making the number available for placement on a medical prescription 10. A first embodiment of this aspect is to print out a quantity of blank prescription forms for a specific physician and comprising the specific physician's encrypted DEA number. A second embodiment of this aspect is to print out a quantity of stickers for a specific physician and comprising the specific physician's encrypted DEA number for later use by placement on a medical prescription or any other item where a DEA number is desired or necessary.

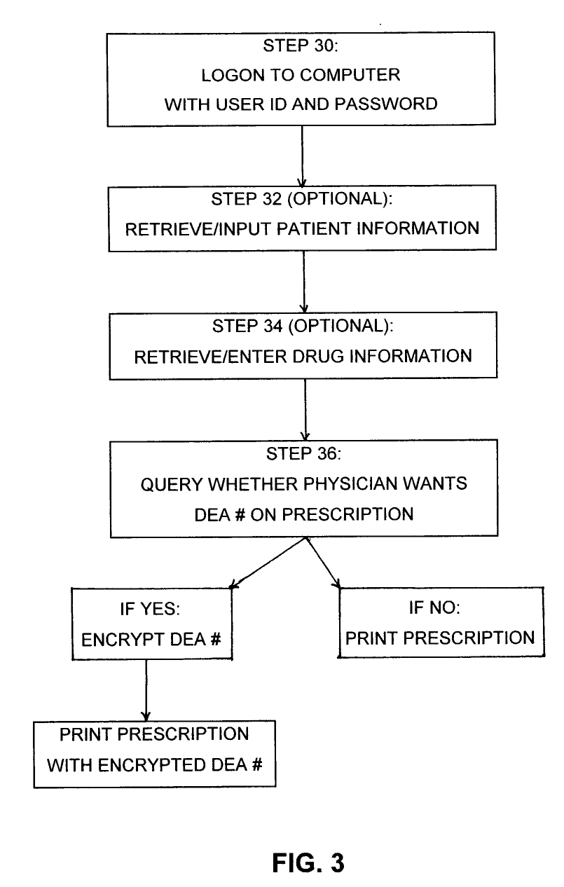

Referring now to FIG. 3, a complete method and system for securely placing a physician's DEA number on a medical prescription 10 is shown in a flowchart. The system can be in many different forms, a basic version of which comprises the steps of:

a. A physician accesses a device capable of printing or causing the printing of an encrypted DEA number. A primary example of such a device is a computer, PDA, electronic programmable typewriter or coding device. A computer will be used as the illustrative example of such a device. Preferably, when the physician logs onto a computer, the logon is a secure logon including a used identification and a password (step 30);

b. If desired to be a part of the method and system, the physician optionally inputs patient data into the computer database or retrieves patient data from the computer database (step 32);

c. If desired to be a part of the method and system, the physician optionally inputs or retrieves information regarding the drug that the physician intends to prescribe (step 34);

d. The physician optionally can be queried whether the DEA number should be placed on the medical prescription (step 36);

e. If the physician wants the DEA number placed on the medical prescription, the DEA number is converted into an encrypted code (step 14); and

f. The encrypted DEA number is printed, either on the medical prescription, on blank medical prescription paper or other appropriate paper, form or sticker (step 16).

More specifically, using a complete prescription writing system as an example, from a graphics interface, the physician logs onto a computer with a user ID and password. In preparing medical prescriptions 10, the physician enters a personal user ID and password, thus activating the prescription writing system and identifying the specific physician who is using the system. The user ID and password help ensure that unauthorized users cannot have access to and do not use the system to prepare unauthorized medical prescriptions. The password has the added benefit of not allowing others to see the records stored on the computer. Further, it has the added benefit of allowing controlled access, which can be particularly helpful if the physician has a practice of having other staff filling the general information of the medical prescription. Such controlled access prescription writing systems are known in the art.

After the physician logs onto the system, the physician can be prompted to enter the patient's data into the system (for new patients) or the physician can be prompted to obtain and/or update the patient's data from the computer database (for existing patients). Such data can include the patient's name, age, sex, other pertinent information required to be present on a medical prescription. By storing the patient's data in databases can help expedite the physician through this aspect of the invention. Such patient databases also are known in the art.

After the physician enters or retrieves the specifics of the patient into or from the system, the physician can be prompted to enter the specifics of the drug the physician intends to prescribe to the patient. The specifics of the drug and the typical doses can be in easy to follow menus and can be stored in existing drug databases in the system. In some cases, the drug may not in the databases and the physician may type in the name and dosages of the drug. Having the drug information in databases can expedite the physician through this aspect of the invention. Such drug databases are known in the art.

Further, physicians may have certain drugs that they prescribe more often than other drugs. A favorite drug database can be created for each physician. Such a database can include the type of the drug, the dosage of the drug and any other pertinent information about the drug. By using such a favorite drug database, the prescription writing process can be greatly simplified and the time it takes to prepare a prescription can be greatly reduced. In this manner, the physician can logon to the system, select a favorite prescription, and print out a secure medical prescription 10 in a very short period of time.

The system can be configured to prompt the physician to enter whether the physician wants the DEA number to be on the medical prescription 10. Alternatively, the physician can select whether the DEA number should be placed on the medical prescription 10 without prompting from the system. When prescribing certain drugs, it is may be a requirement that the DEA number be placed on the prescription. The system can compare the selected drug that the physician intends to prescribe to database on the system (or elsewhere, such as central DEA server) to determine if the physician's DEA number is required for such a medical prescription. If the drug is on the database, the physician's DEA number can be printed on the medical prescription 10.

Optionally, the physician could be required to enter a password before the DEA number is placed on medical prescription 10. This password can be the same password as the password used to log onto the system or it can be a password independent of the password used to log onto the system. The reentrance of the first password, or entrance of a second password at this stage can add a second level of security to the system.

Once the physician elects to place the DEA number on the medical prescription 10, the system can encrypt the physician's DEA number. Methods and technologies for encrypting words, numbers and phrases are known in the art. Thus, the system can employ any encryption/decryption software or technology to convert the DEA number into a barcode or other encrypted code. Once the DEA number has been encrypted, the medical prescription 10 can be printed. The prescription can be printed normally onto the medical prescription paper with ordinary security measures, with the DEA number printed in an encrypted format.

Before the printing of medical prescription 10, the physician can be queried on whether he wants to change the drug information or any other information. The physician can have this opportunity by selecting and entering the appropriate information through a menu-driven system on the system. After selecting the proper item from the proper menu, the information and selections can be reentered. After the drug information has been modified, as the physician wants it, the physician can progress to the next step. Once the drug information has been entered and the physician approves, the system prints medical prescription 10 on medical prescription paper, which can incorporate the traditional security features.

One final step is for the physician to review and sign the medical prescription 10 and to counsel the patient on the medical prescription 10. As the DEA number is encrypted, the patient will be required to take the medical prescription 10 to a pharmacy or other dispensing agency with an encryption reader. However, as barcode readers with encryption software are in prevalent use, most pharmacies and other dispensing agencies can obtain an encryption reader without undue effort.

Thus, a third aspect of the present invention is a method and system for enabling the printing of an encrypted DEA number for use on a medical prescription 10. This system can be as uncomplex as a computer and printer that allows the physician to print out an encrypted DEA number to a complex as a networked interactive computer system comprising physician, patient, and drug data allowing a physician to identify himself or herself, select a patient, select a drug, and print out a completely filled in medical prescription 10 with a few mouse clicks, voice commands or the equivalent in a very short period of time.

As an illustrative example of how the encrypted code operates, the barcode 70 shown in FIG. 1 will be used. In this example, the physician's DEA number is 123456789. When the physician enters the DEA number into the system, or the system recognizes the physician as a physician in the system's physician database, and requests the system to print the DEA number on the medical prescription 10, the system will encrypt the DEA number and print the encrypted DEA number as a barcode 70 on the medical prescription 10. A person reading the barcode 70 with a common barcode scanner will be presented with something other than the DEA number, such as a different number, words, alphanumeric combinations, nonsensical information, or the like. Only the use of a barcode scanner connected to an appropriate encryption/decryption package will allow the DEA number to be read and authorized or accepted.

The encrypted code can be printed out as a series of numbers, letters, or alphanumeric combinations; a barcode; a digital code; or other digital or analog printed encryptions. Preferably, the encrypted code is digitally encrypted and printed out in a digital printed format.

A complete system for executing the steps of the present invention comprises a computer containing or having access to a physician database, a patient database and a drug database, and a medical prescription printer. As medical prescriptions for controlled substances (such as opiates) are required under current law to be in written form, the medical prescription printer also would have to comply with current law. Such medical prescription printers are known in the art; however, any such medical prescription printer must be able to print out codes, such as barcodes, on medical prescriptions 10 or on items such as stickers that can be affixed to medical prescriptions 10. Person of ordinary skill in the art will recognize that a variety of hand-held computers, personal computers, network computers, and printers may be used to execute the steps of the present method.

Preferably, the system contains or can access the databases previously disclosed, as well as other databases that contain information that can allow medical prescription 10 to be prepared more efficiently. For example, such databases could include information such as prescription drug names, patient names, medication dispensing procedures, and medications that require a physician's DEA number on the medical prescription. These databases can be developed by third parties or by persons in the physician's control. Such databases can be on the local hard drive of a computer of the system or may be stored remotely such as on a server computer or central hospital computer.

In another embodiment, the system can be used to print only an encrypted DEA number on a medical prescription 10. In this embodiment, the physician can write a traditional prescription for a controlled substance by hand and use system to place an encrypted DEA number on the medical prescription 10 or on a separate sticker to be placed onto the prescription. The physician can log onto the computer and use the computer to print only the physician's DEA number on the prescription paper or on a sticker or the like. In such an embodiment the queries could be limited to whether the physician wants to add his DEA number to the medical prescription 10.

In another embodiment, the system can be integrated into known methods and devices for preparing medical prescriptions to improve such methods and devices. For illustrative purposes, U.S. Pat. No. 5,884,273 to Sattizahn et al., incorporated herein by reference, discloses a hand-help microcomputer with printer for preparing medical prescriptions. The present invention can incorporated into the Sattizahn '273 device to create a microcomputer with printer that can prepare medical prescriptions in which the physician's DEA number is encrypted. As other systems and methods for preparing medical prescriptions are well established in the prior art, it is understood that the present invention can be retrofitted or otherwise incorporated into the prior art to prepare medical prescriptions in which the physician's DEA number is encrypted.

The foregoing detailed description of the preferred embodiments and the appended figures have been presented only for illustrative and descriptive purposes. They are not intended to be exhaustive and are not intended to limit the scope and spirit of the invention. The embodiments were selected and described to best explain the principles of the invention and its practical applications. One skilled in the art will recognize that many variations can be made to the invention disclosed in this specification without departing from the scope and spirit of the invention.

What is claimed is:

1. A method for producing secure medical prescription comprising the steps of converting the physician's DEA number into an encrypted code for placement onto the medical prescription.

2. The method as claimed in claim 1, wherein the encrypted code is in the form of a digitally printed code.

3. The method as claimed in claim 2, wherein the encrypted code is readable by a code reader equipped with decryption means.

4. The method as claimed in claim 3, wherein the method is incorporated into prescription filling methods.

5. The method as claimed in claim 4, wherein the decryption means is remotely located at a prescription filling location.

6. The method as claimed in claim 4, wherein the decryption means is centrally located and to which a prescription filling location has access.

7. The method as claimed in claim 4, wherein the encrypted code is printed on the medical prescription as a barcode.

8. The method as claimed in claim 1, further comprising the step of printing the encrypted code on a sticker, wherein the sticker is affixed onto the medical prescription.

9. The method as claimed in claim 8, wherein the encrypted code is in the form of a digitally printed code.

10. The method as claimed in claim 9, wherein the encrypted code is readable by a code reader equipped with decryption means.

11. The method as claimed in claim 10, wherein the method is incorporated into prescription filling methods.

12. The method as claimed in claim 11, wherein the decryption means is remotely located at a prescription filling location.

13. The method as claimed in claim 11, wherein the decryption means is centrally located and to which a prescription filling location has access.

14. The method as claimed in claim 11, wherein the encrypted code is printed on the medical prescription as a barcode.

15. A method for producing a secure medical prescription having a physician's encrypted DEA number, comprising the steps of:
a. accessing a device capable of storing the encrypted DEA number; and
b. printing the encrypted DEA number onto a substrate for use as or in connection with a medical prescription

16. The method as claimed in claim 15, wherein the device capable of storing the encrypted DEA number is selected from the group consisting of computers, programmable typewriters, personal digital assistants, and encryption/decryption machines.

17. The method as claimed in claim 16, wherein the substrate is selected from the group consisting of medical prescription paper and blank stickers.

18. The method as claimed in claim 17, wherein the device capable of storing the encrypted DEA number communicates with a device capable of printing the encrypted DEA number and causes the device capable of printing the encrypted DEA number on the substrate.

19. The method as claimed in claim 18, wherein the device capable of storing the encrypted DEA number is further capable of encrypting a DEA number into the encrypted DEA number.

20. A method for producing a secure medical prescription having a physician's DEA number encrypted and located thereon, comprising the steps of:
a. logging onto a computer using a secure logon including a used identification and a password;
b. inputting patient data into a patient database on the computer or retrieving patient data from the patient database on the computer;
c. inputting or retrieving information regarding a drug intended to prescribed;
d. encrypting a prescribing physician's DEA number into an encrypted code; and
e. printing a medical prescription onto medical prescription paper or other appropriate paper with the encrypted DEA number.

21. The method as claimed in claim 20, wherein the encrypted code is readable by a code reader equipped with decryption means.

22. The method as claimed in claim 21, wherein the method is incorporated into prescription filling methods.

23. The method as claimed in claim 22, wherein the decryption means allows the remote decryption of the encrypted code at a prescription filling location.

24. A system for preparing a medical prescription with a physician's DEA number encrypted thereon comprising:
a. a computer comprising a physician database comprising physician DEA numbers;
b. means for converting the physician DEA numbers into an encrypted code; and
c. means for affixing the encrypted code onto a substrate, wherein the substrate is selected from the group consisting of medical prescriptions, medical prescription paper, and substrates capable of being attached to medical prescriptions or medical prescription paper.

25. The system as claimed in claim 24, wherein the encrypted code is in the form of a digitally printed code.

26. The system as claimed in claim 25, wherein the encrypted code is readable by a code reader equipped with decryption means.

27. The system as claimed in claim 26, wherein the method is incorporated into prescription filling methods.

28. The system as claimed in claim 27, wherein the decryption means is remotely located at a prescription filling location.

29. The system as claimed in claim 27, wherein the decryption means is centrally located and to which a prescription filling location has access.

30. The system as claimed in claim 27, wherein the encrypted code is printed on the medical prescription as a barcode.

31. The system as claimed in claim 24, further comprising the step of printing the encrypted code on a sticker, wherein the sticker is affixed onto the medical prescription.

32. The system as claimed in claim 31, wherein the encrypted code is in the form of a digitally printed code.

33. The system as claimed in claim 32, wherein the encrypted code is readable by a code reader equipped with decryption means.

34. The system as claimed in claim 33, wherein the method is incorporated into prescription filling methods.

35. The system as claimed in claim 34, wherein the decryption means is remotely located at a prescription filling location.

36. The system as claimed in claim 34, wherein the decryption means is centrally located and to which a prescription filling location has access.

37. The system as claimed in claim 34, wherein the encrypted code is printed on the medical prescription as a barcode.

38. The system as claimed in claim 34, wherein a physician using the system must enter a user identification and password to log onto the system and the identity of the physician logging onto the system is verified via the used identification and the password.

39. The system as claimed in claim 38, wherein the encrypted code is affixed to the prescription only after confirmation by the physician.

40 The system as claimed in claim 34, further comprising a patient database and a drug database.

41. The system as claimed in claim 40, wherein the encrypted code is readable by a code reader equipped with decryption means incorporated into prescription filling methods.

42. A process for preparing secure medical prescriptions by providing a computer based medical prescription writing program, allowing the secure access to the medical prescription writing program, entering a medical prescription into the medical prescription writing program, and associating a specific physician with a database file comprising the specific physician's DEA number, the improvement comprising the steps of:
a. converting the specific physician's DEA number into an encrypted code; and
b. printing out the encrypted code for use on the medical prescription.

43. The process as claimed in claim 42, wherein the encrypted code containing the physician's DEA number is printed directly onto the medical prescription and the encrypted code is readable by a code reader equipped with decryption means incorporated into prescription filling methods.

44. The process as claimed in claim 42, wherein the encrypted code containing the physician's DEA number is printed onto a sticker to be affixed onto the medical prescription and the encrypted code is readable by a code reader equipped with decryption means incorporated into prescription filling methods.

45. A medical prescription comprising a physician's DEA number in an encrypted format.

46. The medical prescription as claimed in claim 40, wherein the encrypted format does not reveal the physician's DEA number without the use of decryption means.

47. The medical prescription as claimed in claim 46, wherein the encrypted format requires the decryption means to reveal the physician's DEA number.

48. The medical prescription as claimed in claim 47, wherein the encrypted format is an encrypted bar code.

49. The medical prescription as claimed in claim 48, wherein the encrypted bar code is read by a scanner and decrypted to reveal the physician's DEA number.
